(19) United States
(12) Patent Application Publication
(10) Pub. No.: US 2018/0309163 A1
(43) Pub. Date: Oct. 25, 2018

(54) BIPOLAR ALL SOLID-STATE BATTERY

(71) Applicant: KOREA INSTITUTE OF INDUSTRIAL TECHNOLOGY, Cheonan-si (KR)

(72) Inventors: Ho Sung KIM, Gwangju (KR); Min Young KIM, Gwangju (KR); Seung Hoon YANG, Gwangju (KR); Da Hye KIM, Gwangju (KR); Ha Young JUNG, Gwangju (KR); Hye Min RYU, Gwangju (KR); Jin Sub LIM, Gwangju (KR)

(73) Assignee: KOREA INSTITUTE OF INDUSTRIAL TECHNOLOGY, Cheonan-si (KR)

(21) Appl. No.: 15/888,667

(22) Filed: Feb. 5, 2018

(30) Foreign Application Priority Data
Apr. 24, 2017 (KR) 10-2017-0052178
Apr. 24, 2017 (KR) 10-2017-0052179

(51) Int. Cl. H01M 10/0525; H01M 10/04; H01M 10/0585; H01M 4/66; H01M 4/38; H01M 4/134; H01M 10/0562

(52) U.S. Cl. CPC H01M 10/0525; H01M 10/0418; H01M 10/0585; H01M 4/661; H01M 2004/029; H01M 4/134; H01M 10/044; H01M 10/0562; H01M 4/382

(57) ABSTRACT

Disclosed is a bipolar all solid-state battery, which can efficiently control a manufacturing process thereof and can improve electric properties thereof. In an exemplary embodiment, the bipolar all solid-state battery includes a unit cell including a first current collector having a first surface and a second surface opposite to the first surface; a first active material coated on the first surface of the first current collector, a second current collector having a first surface and a second surface opposite to the first surface; a second active material coated on the first surface of the second current collector and facing the first active material; and an all solid-state electrolyte formed between the first active material and the second active material. When a plurality of the unit cells are stacked, the first current collector and the second current collector are connected to each other through surface contact.

### CROSS-REFERENCE TO RELATED APPLICATION

This application claims priority to and the benefit of Korean Patent Application No. 10-2017-0052178 filed on Apr. 24, 2017 and No. 10-2017-0052179 filed on Apr. 24, 2017 in the Korean Intellectual Property Office, and all the benefits accruing therefrom under 35 U.S.C. 119, the contents of which in its entirety are herein incorporated by reference.

### BACKGROUND

### 1. Field

The present invention relates to a bipolar all solid-state battery, which can efficiently control a manufacturing process and can improve electric properties thereof.

### 2. Description of the Related Art

In general, a lithium ion secondary battery has a relatively high energy density and operates at high voltages, compared to other kinds of secondary batteries. Accordingly, the lithium ion secondary battery has been used mainly for information communication devices, such as mobile phones, since it can easily implement compactness and lightness in weight. In addition, in recent years, demands are growing for lithium ion secondary batteries as power sources for large size devices, such as electric vehicles or hybrid automobiles.

The lithium ion secondary battery includes a positive electrode layer, a negative electrode layer and an electrolyte layer disposed therebetween. A non-aqueous liquid or solid, for example, is used as an electrolyte. When a liquid is used as the electrolyte (to be referred to as an ‘electrolyte solution’ hereinafter), the electrolyte solution easily penetrates into the positive electrode layer or the negative electrode layer. Therefore, battery performance can be easily improved owing to low interfacial resistance between an active material contained in a positive or negative electrode layer (to be referred to as an ‘electrode layer’ hereinafter) and an electrolyte solution. However, since the electrolyte solution is combustible, a variety of complex systems are additionally required for securing battery safety. Meanwhile, since an electrolyte in a solid state (to be referred to as a ‘solid electrolyte’ hereinafter) is incombustible, the complex systems can be simplified. Therefore, a lithium ion secondary battery configured to include an incombustible solid electrolyte containing layer (to be referred to as a ‘solid electrolyte layer’ hereinafter) is being proposed and is to be referred to as a solid-state battery.

The above information disclosed in this Background section is only for enhancement of understanding of the background of the described technology and therefore it may contain information that does not form the prior art that is already known in this country to a person of ordinary skill in the art.

### SUMMARY

Embodiments of the present invention provide a bipolar all solid-state battery, which can efficiently control a manufacturing process thereof and can improve electric properties thereof.

The above and other aspects of the present invention will be described in or be apparent from the following description of exemplary embodiments.

According to an aspect of the present invention, there is provided a bipolar all solid-state battery including a unit cell including a first current collector having a first surface and a second surface opposite to the first surface, a first active material coated on the first surface of the first current collector, a second current collector having a first surface and a second surface opposite to the first surface, a second active material coated on the first surface of the second current collector and facing the first active material, and an all solid-state electrolyte formed between the first active material and the second active material, wherein when a plurality of the unit cells are stacked, the first current collector and the second current collector are connected to each other through surface contact.

The first current collector may be made of aluminum or an aluminum alloy.

The second current collector may be made of copper or a copper alloy.

The first current collector and the second current collector may be made of stainless steel (SUS), nickel or a nickel alloy.

The bipolar all solid-state battery may further include an adhesive or paste formed on at least one surface of at least one of the first current collector and the second current collector, the adhesive or paste including a metal selected from the group consisting of platinum, silver, gold and nickel.

In addition, the first current collector may be configured to have a larger area than the second current collector.

In addition, the all solid-state electrolyte may be configured to have a larger area than the first and second current collectors.

The bipolar all solid-state battery may further include an insulation film formed on boundaries between the first current collector and the second current collector when the between the first current collector and the second current collector when the unit cells are stacked.

Here, the insulation film may include one selected from the group consisting of polyimide (PI), polyethylene (PE) and polypropylene (PP).

In addition, the insulation film includes a throughhole formed therein to expose the first current collector and the second current collector being in surface contact.

In addition, the insulation film may include styrene butadiene rubber (SBR) coated on at least one of its top and bottom portions to then be attached to at least one of the first current collector and the second current collector.

Further, surface treatment may be performed on at least one of the second surface of the first current collector and the second surface of the second current collector.

According to another aspect of the present invention, there is provided a bipolar all solid-state battery comprising a unit cell including a bipolar current collector having a first surface and a second surface opposite to the first surface, a first active material coated on the first surface of the bipolar current collector, a second active material coated on the second surface of the bipolar current collector, and an all solid-state electrolyte formed between the first active material and the second active material, wherein the second active material is formed by attaching a lithium foil to the second surface of the bipolar current collector.

The bipolar current collector may be made of stainless steel (SUS), nickel, a nickel alloy or a clad metal of aluminum and copper.

The first active material may be configured to have a larger area than the second active material.

The all solid-state electrolyte may be configured to have a larger area than the first and second active materials.

The bipolar all solid-state battery may further include an insulation film formed on a top surface of the bipolar current collector to surround the second active material.

The insulation film may include one selected from the group consisting of polyimide (PI), polyethylene (PE) and polypropylene (PP).

According to still another aspect of the present invention, there is provided a method of manufacturing a bipolar all solid-state battery, the method including providing a bipolar current collector structure by winding the bipolar current collector on a roll, the bipolar current collector including a first active material formed on its first surface and a second active material formed on its second surface, providing an all solid-state electrolyte structure by winding an all solid-state electrolyte on a separate roll, and supplying the bipolar current collector structure and the all solid-state electrolyte structure between two rotating rollers and compressing the structures using the rollers.

The second active material may be formed by attaching a lithium foil to the second surface of the bipolar current collector.

As described above, the bipolar all solid-state battery according to the present invention includes a unit cell including current collectors having active materials coated on top and bottom surfaces thereof and an all solid-state electrolyte formed between the active materials, and when the unit cells are connected in series, in parallel or in series/parallel, a bipolar structure is formed through surface contact of the current collectors, thereby easily forming a bipolar all solid-state battery structure.

In addition, a negative electrode current collector is formed to have a larger area than a positive electrode current collector, and the all solid-state electrolyte is formed to have a larger area than the positive and negative electrode current collectors, thereby preventing the active materials from moving and ultimately preventing electric properties from deteriorating due to the moving active materials.

In addition, when the unit cells are stacked, an insulation film is formed between the unit cells stacked, thereby preventing electric properties from deteriorating due to contact between the all solid-state electrolytes of the respective unit cells.

Alternatively, the bipolar all solid-state battery according to the present invention includes a unit cell including a bipolar current collector having active materials coated on opposite surfaces thereof and an all solid-state electrolyte formed between the active materials, and when the unit cell is connected to a neighboring unit cell in series, a bipolar structure is formed through surface contact between the current collectors of the respective unit cells, thereby easily forming a bipolar all solid-state battery structure.

In addition, in forming a negative electrode active material, a lithium foil is attached to a bipolar current collector, thereby simply and easily forming the bipolar all solid-state battery.

In addition, in forming a unit cell, a structure including an active material coated on a bipolar current collector is formed by winding the bipolar current collector on a roll and a structure including an all solid-state electrolyte is also formed by winding the all solid-state electrolyte on a separate roll. In such a state, the structures are compressed between two rollers, thereby easily manufacturing a large quantity of bipolar all solid-state batteries.

In addition, a positive electrode active material is coated on a larger area than a negative electrode active material, and the all solid-state electrolyte is coated on a larger area than the positive and negative electrode active materials, thereby preventing flowable lithium ions from moving in the negative electrode active material and ultimately preventing electric properties from deteriorating due to the moving lithium ions.

In addition, when the unit cells are stacked, an insulation film is formed between the unit cells stacked, thereby preventing electric properties from deteriorating due to contact between the all solid-state electrolytes of the respective unit cells.

### BRIEF DESCRIPTION OF THE DRAWINGS

The above and other features and advantages of the present invention will become more apparent by describing in detail preferred embodiments thereof with reference to the attached drawings in which:

FIG. 1 is a schematic view illustrating a unit cell of a bipolar all solid-state battery according to an embodiment of the present invention;

FIG. 2 is a schematic view illustrating a bipolar all solid-state battery stack according to an embodiment of the present invention;

FIG. 3 is a schematic view illustrating a unit cell of a bipolar all solid-state battery according to another embodiment of the present invention;

FIG. 4 is a schematic view illustrating a stack of the bipolar all solid-state battery according to another embodiment of the present invention;

FIG. 5 is a schematic view illustrating a stack of unit cells of a bipolar all solid-state battery according to still another embodiment of the present invention;

FIG. 6 is a plan view illustrating a film sheet used in the bipolar all solid-state battery according to still another embodiment of the present invention;

FIGS. 7A and 7B are plan views illustrating a first current collector before and after laminating the film sheet used in the bipolar all solid-state battery according to still another embodiment of the present invention;

FIGS. 8A and 8B are plan views illustrating a second current collector before and after laminating a film sheet used in the bipolar all solid-state battery according to still another embodiment of the present invention;

FIG. 9 is a schematic view illustrating a state in which tabs are connected to the bipolar all solid-state battery according to an embodiment of the present invention;

FIG. 10 is a graph illustrating performance evaluation results of the bipolar all solid-state battery according to an embodiment of the present invention;

FIG. 11 is a schematic view illustrating a stack of a bipolar all solid-state battery according to still another embodiment of the present invention;

FIG. 12 illustrating a process of attaching an all solid-state electrolyte to the bipolar all solid-state battery according to still another embodiment of the present invention;

FIG. 13 is a schematic view illustrating a stack of a bipolar all solid-state battery according to another embodiment of the present invention;

FIG. 14 is a schematic view illustrating a stack of a bipolar all solid-state battery according to still another embodiment of the present invention;

FIG. 15 is a plan view illustrating a film sheet used in the bipolar all solid-state battery according to still another embodiment of the present invention;

FIGS. 16A and 16B are plan views illustrating a bipolar current collector before and after laminating a film sheet used in the bipolar all solid-state battery according to still another embodiment of the present invention; and

FIG. 17 is a graph illustrating performance evaluation results of the bipolar all solid-state battery according to still another embodiment of the present invention.

### DETAILED DESCRIPTION

Hereinafter, the present invention will be described in detail.

Hereinafter, exemplary embodiments will be described in detail with reference to accompanying drawings.

The invention may, however, be embodied in many different forms and should not be construed as being limited to the embodiments set forth herein; rather, these embodiments are provided so that this disclosure will be thorough and complete, and will fully convey the concept of the invention to those skilled in the art.

Furthermore, in the drawings, the thicknesses of layers and regions are exaggerated for clarity, and like reference numerals in the drawings denote like elements. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more can features, integers, steps, operations, elements, components, and/or groups thereof.

Although numerical terms (e.g., “first” and “second”) are used herein to describe various members, parts, regions, layers and/or sections, these members, parts, regions, layers and/or sections are not to be limited by these terms. These terms are only used to distinguish one member, part, region, layer or section from another member, part, region, layer or section. Thus, for example, a first member, part, region, layer or section discussed below could be termed a second, part, region, layer or section without departing from the teachings of the illustrated embodiments.

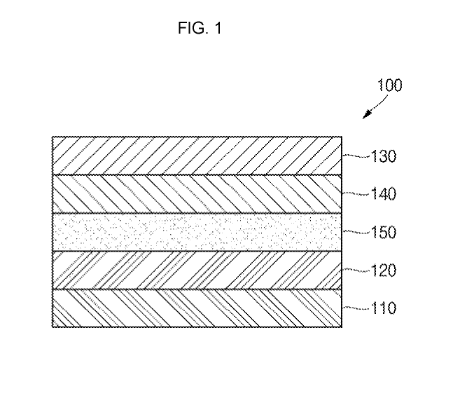

FIG. 1 is a schematic view illustrating a unit cell of a bipolar all solid-state battery according to an embodiment of the present invention.

First, referring to FIG. 1, the bipolar all solid-state battery 100 according to an embodiment of the present invention may include a unit cell including a first current collector 110, a first active material 120, a second current collector 130, a second active material 140 and a solid electrolyte 150.

The first current collector 110 may function as a positive electrode current collector. To this end, the first current collector 110 is preferably made of aluminum or an aluminum alloy. In addition, when the first current collector 110 is made of the same material with the second current collector 130, the first current collector 110 and the second current collector 130 may be made of stainless steel (SUS), nickel or a nickel alloy. In addition, in order to reduce electrical resistance applied when the unit cell is in contact with and connected to a neighboring unit cell, an adhesive or paste made of a metal selected from the group consisting of platinum, silver, gold and nickel may further be formed on a surface of the first current collector 110, specifically on the surface of the first current collector 110, which is exposed to the outside of the unit cell. In addition, in order to reduce contact resistance applied during surface contact, surface treatment may further be performed on the first current collector 110. For example, scratches may be produced on the surface of the first current collector 110. In such a case, the contact resistance can be reduced by increasing a contact area when the unit cells are stacked.

The first active material 120 is formed on one surface of the first current collector 110. When the first active material 120 functions as a positive electrode active material, a generally well-known positive electrode active material, such as nickel cobalt manganese (NCM), lithium cobalt oxide (LCO) or nickel cobalt aluminum (NCA), may be used in combination with an ionic conductor, such as a Nasicon-based oxide, a perovskite-based oxide or a garnet-type oxide, a sulfide-based solid electrolyte, such as binary sulfide, a polymer having ionic conductivity and capable of functioning as a binder, such as PEO or PPO, and an electronically conductive material, such as Super P or CNT, etc. However, the present invention does not limit the material of the first active material 120 to those listed herein.

The second current collector 130 may be formed on the other surface of the unit cell 100, opposite to and facing the first current collector 110. The second current collector 130 may function as a negative electrode current collector. The second current collector 130 is preferably made of copper or a copper alloy. In addition, when the second current collector 130 is made of the same material with the first current collector 110, it may be made of stainless steel (SUS), nickel or a nickel alloy, like the first current collector 110.

Here, when the unit cell 100 is connected to a neighboring unit cell 100 in series by stacking the unit cells 100, the second current collector 130 may be brought into contact with the first current collector 110 through surface contact, thereby forming a bipolar electrode. Of course, when the unit cell 100 is connected to the neighboring unit cell 100 in series by stacking the unit cells 100, a bipolar electrode can also be formed by bringing the second current collector 130 of the unit cell 100 into contact with the second current collector 130 of the neighboring unit cell 100 stacked through surface contact.

Therefore, like in a case of the first current collector 110, in order to reduce electrical resistance applied during surface contact, an adhesive or paste made of a metal selected from the group consisting of platinum, silver, gold and nickel may also further be formed on a surface of the second current collector 130. In addition, in order to reduce contact resistance applied during surface contact, surface treatment may further be performed on the second current collector 130 as well. For example, scratches may be formed on the surface of the second current collector 130.

The second active material 140 may be formed on one surface of the second current collector 130. Like the first active material 120, the second active material 140 may include a graphite-based lithium ion storage material, silicon oxide (SiO₂) or tin oxide (SnO₂), and may be formed using a composite electrode including an ionically conductive material, an electronically conductive material, a binder and a conductive agent, or using a lithium metal.

The solid electrolyte 150 may be formed by preparing a solid electrolyte slurry by mixing a lithium lanthanum zirconium oxide (LLZO) represented by the general formula LiₓLa_{y}Zr_{z}O₁₂, where x is a positive integer in the range from 6 to 9, y is a positive integer in the range from 2 to 4, and z is a positive integer in the range from 1 to 3, an ionically conductive binder (e.g., PEO) and a lithium salt with an organic solvent (e.g., ACN). Examples of the lithium salt may include, but not limited to, LiClO₄. Additionally, the lithium salt may be at least one selected from the group consisting of LiCl, LiBr, LiI, LiClO₄, LiBF₄, LiBlOCl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, a lower aliphatic carboxylic acid lithium, lithium tetraphenyl borate, or mixtures of two or more of these compounds.

Hereinafter, a process of manufacturing a bipolar all solid-state battery in a stacked structure according to an embodiment of the present invention will be described.

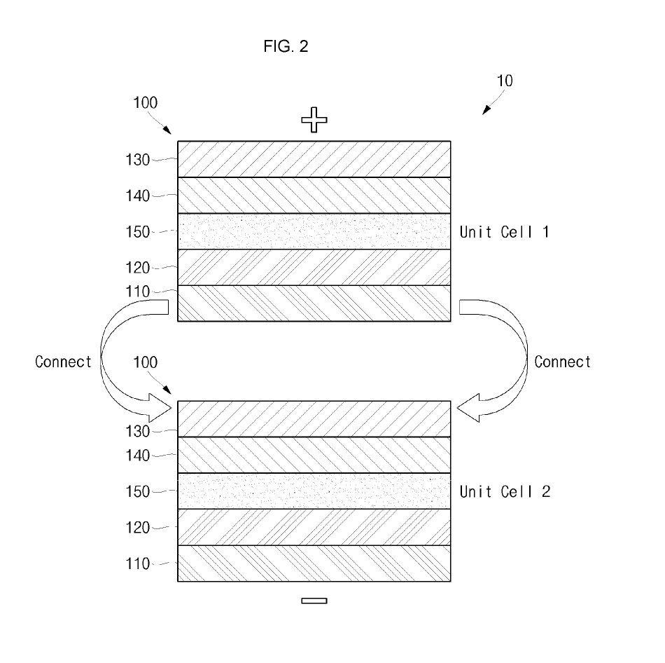

FIG. 2 is a schematic view illustrating a stack of a bipolar all solid-state battery according to an embodiment of the present invention.

Referring to FIG. 2, a bipolar all solid-state battery stack 10 according to an embodiment of the present invention includes a plurality of unit cells 100 stacked and connected in series.

Specifically, in FIG. 2 illustrating the plurality of unit cells 100 are vertically stacked, the second current collector 130 of the underlying unit cell 100 may be in contact with and connected with the first current collector 110 of the overlying unit cell 100.

Therefore, with this connection structure, each of the unit cells 100 includes a bipolar all solid-state battery, and the respective unit cells 100 may be connected to each other in series, in parallel or in series/parallel according to the overall capacity required.

Separately, an adhesive or paste, which is made of a metal selected from the group consisting of platinum, silver, gold and nickel, may further be formed on surfaces of the first current collector 110 and the second current collector 130 of the unit cells 100 being in surface contact, as described above, thereby lowering electrical resistance applied during the surface contact.

In addition, after stacking the unit cells 100, the battery stack 10 may have a completed electrical connection structure, so that it is not necessary to separately press the battery stack 10. Therefore, the process of forming the battery stack 10 may be simplified, thereby manufacturing the battery stack 10 with high quality and high efficiency.

Hereinafter, a structure of a bipolar all solid-state battery according to another embodiment of the present invention will be described.

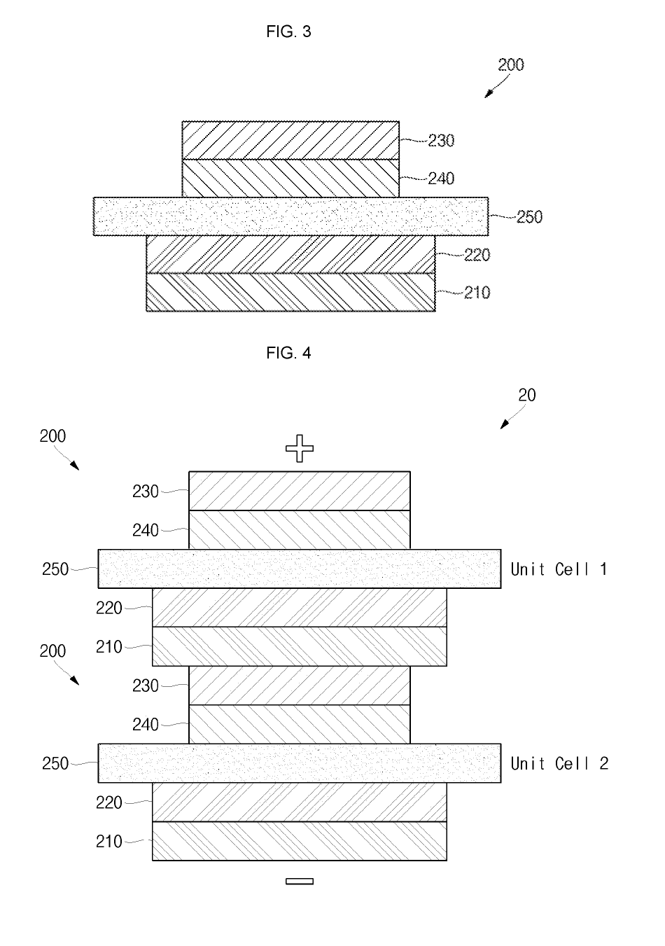

FIG. 3 is a schematic view illustrating a unit cell of a bipolar all solid-state battery according to another embodiment of the present invention. FIG. 4 is a schematic view illustrating a stack of the bipolar all solid-state battery according to another embodiment of the present invention.

Referring to FIG. 3, the unit cell 200 of the bipolar all solid-state battery may include a first current collector 210, a first active material 220, a second current collector 230, a second active material 240, and an all solid-state electrolyte 250. Here, ingredients of various elements of the unit cell 200 may be the same as those of corresponding elements of the unit cell 100 according to the previous embodiment, and descriptions thereof will not be repeated for brevity.

In the present embodiment, the first current collector 210 and the first active material 220 coated on the first current collector 210 may be configured to have larger areas than the second current collector 230 and the second active material 240 coated on the second current collector 230.

The reason of making such an area difference as stated above is to make the first current collector 210 have a larger area than the second current collector 230 in contact with the first current collector 210 in a battery stack 20 in which the unit cells 200 are stacked, as illustrated in FIG. 4. In this case, it is possible to prevent ingredients of the second active material 240 coated on the second current collector 230, specifically flowable lithium ions of the negative electrode active material, from overpassing the first current collector 210 and the first active material 220. Therefore, the bipolar all solid-state battery according to another embodiment of the present invention is configured to prevent electric properties, e.g., short-circuits, from deteriorating due to the moving active materials in the battery stack 20.

Referring to FIGS. 3 and 4, the all solid-state electrolyte 250 may be configured to have a larger area than other elements. With this configuration, it is possible to efficiently prevent lithium ions in an active material, specifically in the second active material 240, from overpassing the first active material 220 of the underlying unit cell 200.

Hereinafter, a structure of a bipolar all solid-state battery according to still another embodiment of the present invention will be described.

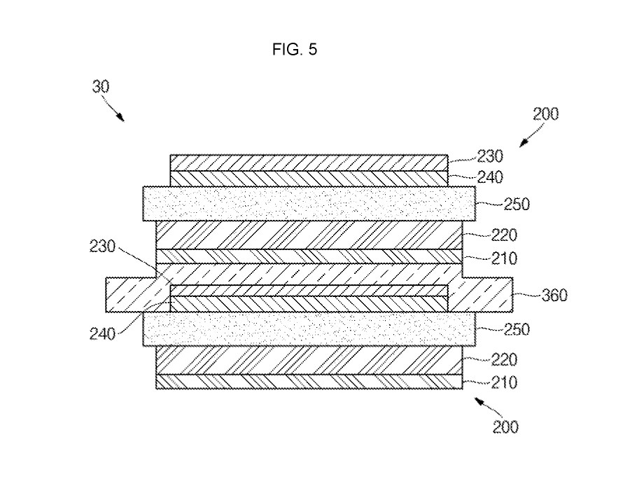

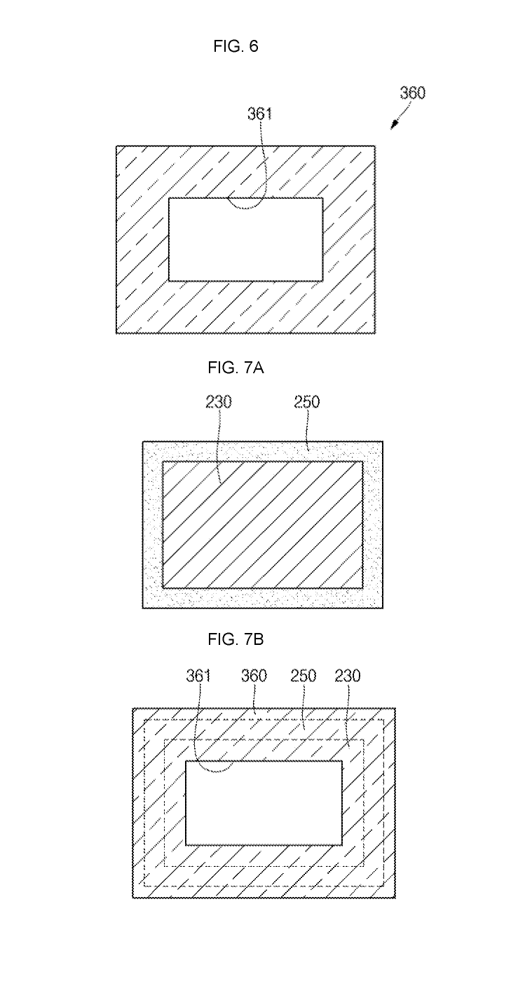

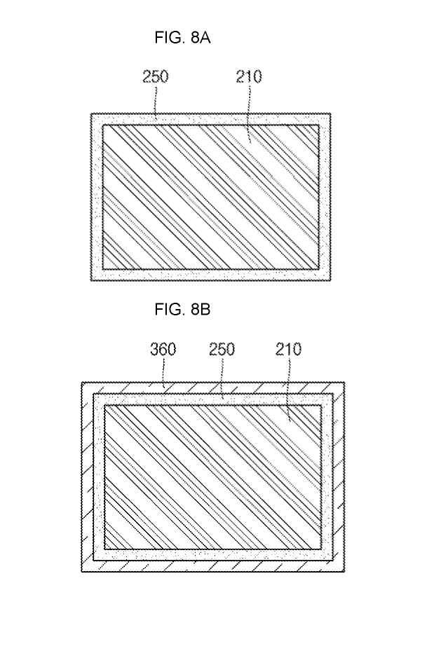

FIG. 5 is a schematic view illustrating a stack of unit cells of a bipolar all solid-state battery according to still another embodiment of the present invention. FIG. 6 is a plan view illustrating a film sheet used in the bipolar all solid-state battery according to still another embodiment of the present invention. FIGS. 7A and 7B are plan views illustrating a first current collector before and after laminating the film sheet used in the bipolar all solid-state battery according to still another embodiment of the present invention. FIGS. 8A and 8B are plan views illustrating a second current collector before and after laminating a film sheet used in the bipolar all solid-state battery according to still another embodiment of the present invention. The same reference numerals are denoted by the same elements as those of the previous embodiment, and the following description will focus on differences between the present embodiment and the previous embodiment.

Referring to FIG. 5, a battery stack 30 of the bipolar all solid-state battery according to still another embodiment of the present invention may include unit cells 200 each including a first current collector 210, a first active material 220, a second current collector 230, a second active material 240 and an all solid-state electrolyte 250, like the battery stack 20 according to the previous embodiment. Meanwhile, the battery stack 30 may further include an insulation film 360 between the second current collector 230 of the underlying unit cell 200 and the first current collector 210 of the overlying unit cell 200.

The insulation film 360 basically includes an insulating material, such as polyimide (PI), polyethylene (PE) or polypropylene (PP), and includes a throughhole 361 formed therein. The throughhole 361 enables a contact between the second current collector 230 of the underlying unit cell 200 and the first current collector 210 of the overlying unit cell 200 in the battery stack 30, thereby connecting the unit cells 200 to each other in series, in parallel or in series/parallel.

The insulation film 360 may be maintained in a state in which it is attached to the upper and lower current collectors 210 and 230 using a spray adhesive, although not separately illustrated. The spray adhesive may be made of a material having high stability in view of electrochemical potential.

As the result of attaching the insulation film 360, a contact between the all solid-state electrolytes 250 in the battery stack 30 can be fundamentally prevented, thereby preventing electrical properties, such as short-circuits, from deteriorating.

Hereinafter, a structure in which tabs are connected to the bipolar all solid-state battery according to an embodiment of the present invention will be described.

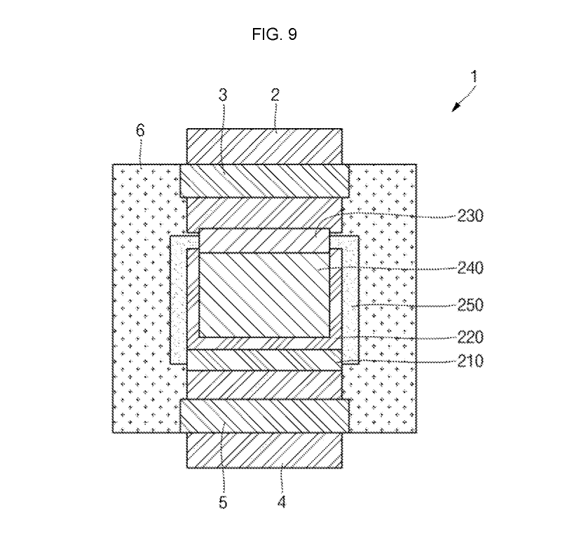

FIG. 9 is a schematic view illustrating a state in which tabs are connected to the bipolar all solid-state battery according to an embodiment of the present invention.

Specifically, FIG. 9 is a layout view in which various elements are arrayed in an area order, not a plan view in which various elements are arrayed in a stacking order.

Referring to FIG. 9, in order to house the bipolar all solid-state battery according to an embodiment of the present invention in a pouch 6 to then seal the resultant structure, the bipolar all solid-state battery may include a first tab 2 connected to the overlying second current collector 230 and a second tab 4 connected to the underlying first current collector 210.

The first tab 2 and the second tab 4 may be enlarged to have widths corresponding to those of the current collectors 230 and 210, respectively. Therefore, when charging and discharging operations are performed, current may flow through the large-area tabs 2 and 4, thereby improving a current density and increasing output efficiency.

In addition, the first and second tabs 2 and 4 may further include sealing members 3 and 5 for sealing the tabs 2 and 4 at boundaries between each of the first and second tabs 2 and 4 and the pouch 6, respectively.

Hereinafter, performance evaluation results of the bipolar all solid-state battery according to an embodiment of the present invention will be described.

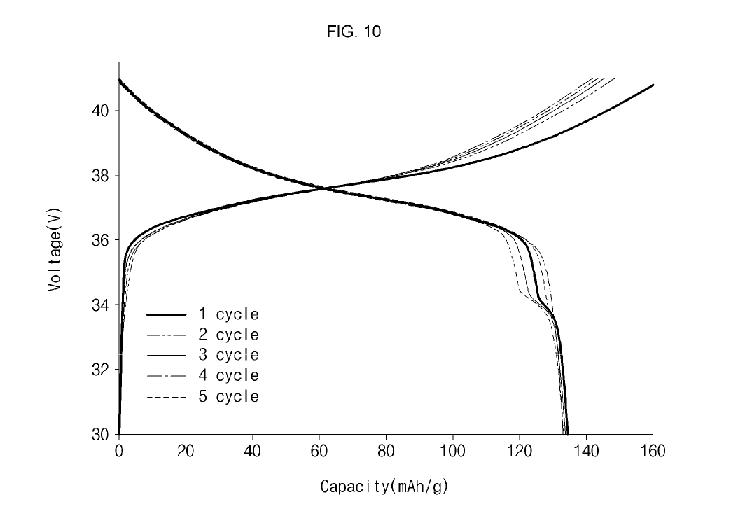

FIG. 10 is a graph illustrating performance evaluation results of the bipolar all solid-state battery according to an embodiment of the present invention.

Referring to FIG. 10, performance tests were carried out on trial products of the bipolar all solid-state battery according to an embodiment of the present invention, in which 10 unit cells 100 are stacked and connected in series and finally assembled using the pouch 6 shown in FIG. 9.

As confirmed from the results illustrated in FIG. 10, after the battery stack 10 was charged, an open circuit voltage (OCV) of the battery stack 10 was approximately 42 V and an average discharge voltage of the battery stack 10 was 37 V, which is equal to a discharge voltage of each unit cell 100, that is, approximately 3.7 V. In addition, when the battery stack 10 was discharged with a current density of 0.05 C at 70° C., a capacity of the battery stack 10 was identified as approximately 133 mAh/g, which is substantially equal to a discharge capacity of each unit cell 10. In addition, the battery stack 10 demonstrated superior reversibility during charge and discharge cycles. Therefore, the cell/stack of the bipolar all solid-state battery according to the present invention can be easily manufactured and quality problems, such as short-circuits, can be efficiently controlled.

Hereinafter, a stacked structure of a bipolar all solid-state battery according to another embodiment of the present invention will be described.

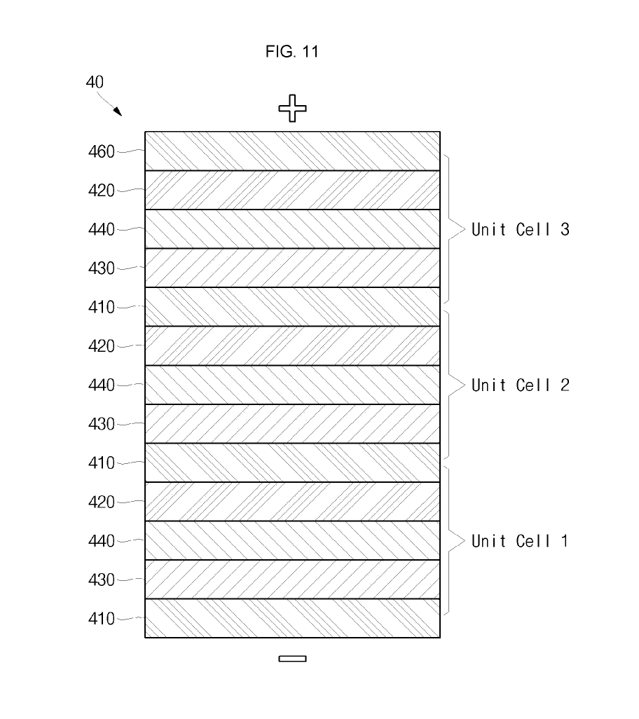

FIG. 11 is a schematic view illustrating a stack of a bipolar all solid-state battery according to still another embodiment of the present invention.

First, referring to FIG. 11, a bipolar all solid-state battery stack 40 according to still another embodiment of the present invention may be manufactured by stacking unit cells each including a bipolar current collector 410, a first active material 420, a second active material 430 and a solid electrolyte 440. In addition, a first outer current collector 450 and a second outer current collector 460 may further be formed on outermost surfaces of the stack 40.

In addition, in order to reduce electrical resistance applied when the unit cell is in contact with and connected to a neighboring unit cell, an adhesive or paste made of a metal selected from the group consisting of platinum, silver, gold and nickel may further be formed on a surface of the bipolar current collector 410, specifically, the surface of the bipolar current collector 410, which is exposed to the outside of the unit cell.

The first active material 420 is formed on one surface of the first current collector 410. When the first active material 420 functions as a positive electrode active material, a generally well-known positive electrode active material, such as nickel cobalt manganese (NCM), lithium cobalt oxide (LCO) or nickel cobalt aluminum (NCA), may be used in combination with an ionic conductor, such as a Nasicon-based oxide, a perovskite-based oxide or a garnet-type oxide, a sulfide-based solid electrolyte, such as binary sulfide, a polymer having ionic conductivity and capable of functioning as a binder, such as PEO or PPO, and an electronically conductive material, such as Super P or CNT, etc. However, the present invention does not limit the material of the first active material 420 to those listed herein.

The second active material 430 may be coated on one surface of the bipolar current collector 410, that is, on the other surface opposite to the one surface without the first active material 420 coated thereon. That is to say, the second active material 430 is formed to be symmetrical with the first active material 420 in view of the bipolar current collector 410.

Like the first active material 420, the second active material 430 may include a graphite-based lithium ion storage material, silicon oxide (SiO₂) or tin oxide (SnO₂), and may be formed using a composite electrode using an ionically conductive material, an electronically conductive material, a binder and a conductive agent, or using a lithium metal.

More preferably, the second active material 430 may also be formed by attaching a thin foil made of lithium, instead of graphite to the other surface of the bipolar current collector 410. That is to say, the second active material 430 can be simply and easily formed by attaching a lithium foil to the bipolar current collector 410, instead of coating a separate material on the bipolar current collector 410. Specifically, in this case, the second active material 430 has an advantage of increasing ionic capacity, compared to common graphite.

The solid electrolyte 440 may be formed by preparing a solid electrolyte slurry by mixing a lithium lanthanum zirconium oxide (LLZO) represented by the general formula LiₓLa_{y}Zr_{z}O₁₂, where x is a positive integer in the range from 6 to 9, y is a positive integer in the range from 2 to 4, and z is a positive integer in the range from 1 to 3, an ionically conductive binder (e.g., PEO) and a lithium salt with an organic solvent (e.g., ACN). In addition, examples of the lithium salt may include, but not limited to, LiClO₄. Additionally, the lithium salt may be at least one selected from the group consisting of LiCl, LiBr, LiI, LiClO₄, LiBF₄, LiB10Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, a lower aliphatic carboxylic acid lithium, lithium tetraphenyl borate, or mixtures of two or more of these compounds.

The first outer current collector 450 may function as a current collector of the bottommost unit cell. In this case, the second active material 430 may be formed on one surface of the first outer current collector 450. However, no active material may be coated on the other surface of the first outer current collector 450. Therefore, the first outer current collector 450 may not be necessarily a bipolar current collector, so that it may be made of copper or a copper alloy with a view to increasing the efficiency.

The second outer current collector 460 may function as a current collector of the topmost unit cell. In this case, the first active material 420 may be formed on one surface of the second outer current collector 460. However, no active material may be coated on the other surface of the second outer current collector 460. Therefore, the second outer current collector 460 may not be necessarily a bipolar current collector, either, so that it may be made of aluminum or an aluminum alloy with a view to increasing the efficiency.

Meanwhile, the battery stack 40 may be formed by repeatedly stacking unit cells each including the bipolar current collector 410 between the first outer current collector 450 and the second outer current collector 460, the first active material 420, the second active material 430 and the all solid-state electrolyte 440, thereby connecting the unit cells to each other in series.

Specifically, the battery stack 40 is configured such that the all solid-state electrolytes 440 are combined in a state in which the first active material 420 and the second active material 430 are formed on opposite surfaces of the bipolar current collector 410, respectively, and a large quantity of battery stacks can be provided in advance. In addition, a final structure of the battery stack 40 basically comprised of unit cells each including the all solid-state electrolyte 440 formed between the first active material 420 and the second active material 430 can be achieved by stacking the respective structures.

Hereinafter, a method of manufacturing a bipolar all solid-state battery according to still another embodiment of the present invention will be described in more detail.

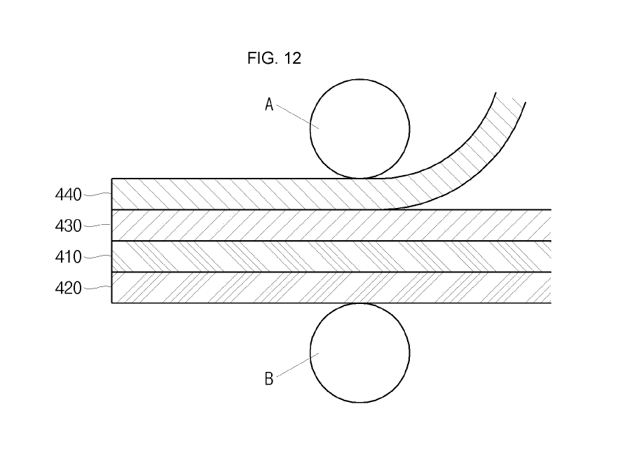

FIG. 12 illustrating a process of attaching an all solid-state electrolyte to the bipolar all solid-state battery according to still another embodiment of the present invention.

Referring to FIG. 12, a bipolar all solid-state battery 40 according to still another embodiment of the present invention may be configured such that the first active material 420 and the second active material 430 are formed on opposite surfaces of the bipolar current collector 410, and the all solid-state electrolyte 440 may be separately provided. That is to say, a structure, including the bipolar current collector 410, the first active material 420 and the second active material 430, may be wound on a roll, and the all solid-state electrolyte 440 may also be wound on a separate roll.

In addition, as illustrated in FIG. 12, the structure, including the bipolar current collector 410, the first active material 420 and the second active material 430, and the all solid-state electrolyte 440, may be supplied between two rollers A and B by being unrolled from the respective rolls, and may be compressed using the rollers A and B. According to this process, the structure, including the bipolar current collector 410, the first active material 420 and the second active material 430, and the all solid-state electrolyte 440, are formed in advance to then be combined with each other using a roll-to-roll process, a large quantity of unit cells may be easily manufactured.

Therefore, the cost and process for manufacturing the bipolar all solid-state battery 40 according to still another embodiment of the present invention can be reduced.

Hereinafter, a stacked structure of a bipolar all solid-state battery according to another embodiment of the present invention will be described.

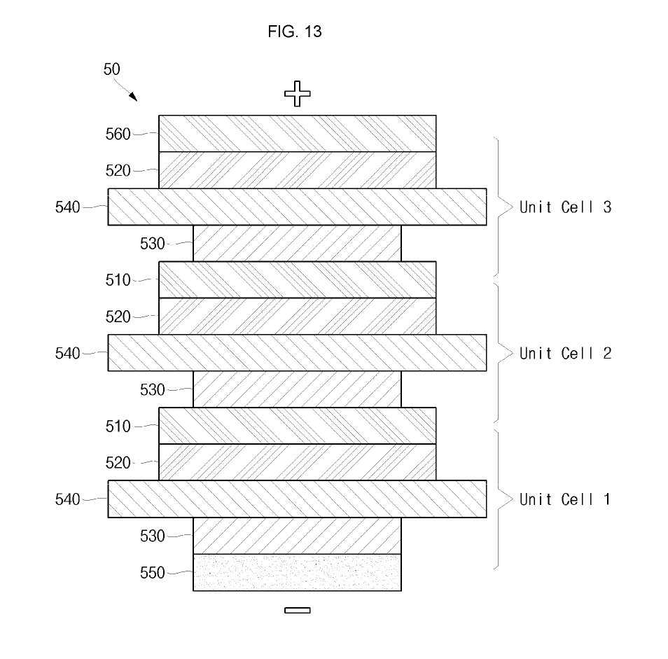

FIG. 13 is a schematic view illustrating a stack of a bipolar all solid-state battery according to another embodiment of the present invention.

Referring to FIG. 13, a bipolar all solid-state battery stack 50 according to another embodiment of the present invention may include a bipolar current collector 510, a first active material 520, a second active material 530, and an all solid-state electrolyte 540. In addition, a first outer current collector 550 and a second outer current collector 560 may be provided on outermost surfaces of the battery stack 50. Here, various elements of the battery stack 50 according to another embodiment of the present invention may be the same as those of the battery stack 40 according to still another embodiment of the present invention, and descriptions thereof will not be repeated for brevity.

In the present embodiment, the bipolar current collector 510 and the first active material 520 coated on the bipolar current collector 510 may have larger areas than the second active material 530 coated on the bipolar current collector 510.

The reason making such an area difference as stated above is to make the first active material 520 arrayed in a larger area than the second active material 530 in the battery stack 50 in which the unit cells are stacked, as illustrated in FIG. 13. In this case, it is possible to prevent ingredients of the second active material 530, specifically flowable lithium of the negative electrode active material, from overpassing the first active material 520. Therefore, the bipolar all solid-state battery according to another embodiment of the present invention is configured to prevent electric properties, e.g., short-circuits, from deteriorating due to the moving active materials in the battery stack 50.

Referring to FIG. 13, the all solid-state electrolyte 540 may be configured to have a larger area than other elements. With this configuration, it is possible to efficiently prevent an active material, specifically lithium ions in the second active material 530, from overpassing the first active material 520 of the underlying unit cell.

Hereinafter, a structure of a bipolar all solid-state battery according to still another embodiment of the present invention will be described.

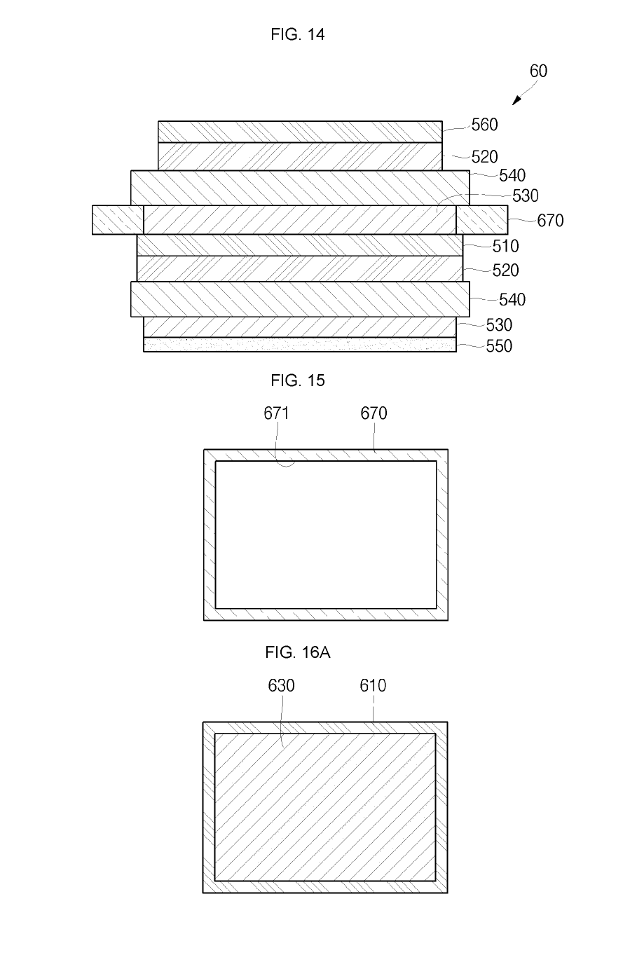

FIG. 14 is a schematic view illustrating a stack of a bipolar all solid-state battery according to still another embodiment of the present invention. FIG. 15 is a plan view illustrating a film sheet used in the bipolar all solid-state battery according to still another embodiment of the present invention. FIGS. 16A and 16B are plan views illustrating a bipolar current collector before and after laminating a film sheet used in the bipolar all solid-state battery according to still another embodiment of the present invention. The same reference numerals are denoted by the same elements as those of the previous embodiment, and the following description will focus on differences between the present embodiment and the previous embodiment.

Referring to FIG. 14, a bipolar all solid-state battery stack 60 according to still another embodiment of the present invention may include a bipolar current collector 510, first active materials 520, second active materials 530, all solid-state electrolytes 540, a first outermost current collector 550 and a second outermost current collector 560, which are the same as the corresponding elements of the battery stack 20 according to the previous embodiment of the present invention. The bipolar all solid-state battery stack 60 may further include an insulation film 670 formed on the underlying bipolar current collector 510 to surround the second active material 530.

The insulation film 670 basically includes an insulating material, such as polyimide (PI), polyethylene (PE) or polypropylene (PP), and has a throughhole 671 formed therein. In the illustrated stacked structure, the throughhole 671 enables a contact between the second active material 530 and the all solid-state electrolyte 540 stacked thereon, thereby connecting the unit cells to each other in series.

The insulation film 670 may allow the second active material 530 and the all solid-state electrolyte 540 positioned up and down to be maintained in a state in which it is attached to the second active material 530 and the all solid-state electrolyte 540 using a spray adhesive, although not separately illustrated. The spray adhesive may be formed using a material having high stability in view of electrochemical potential.

As the result of attaching the insulation film 670, it is possible to fundamentally prevent the all solid-state electrolytes 540 from contacting each other in the battery stack 60, thereby preventing electric properties, e.g., short-circuits, from deteriorating.

Hereinafter, performance evaluation results of the bipolar all solid-state battery according to still another embodiment of the present invention will be described.

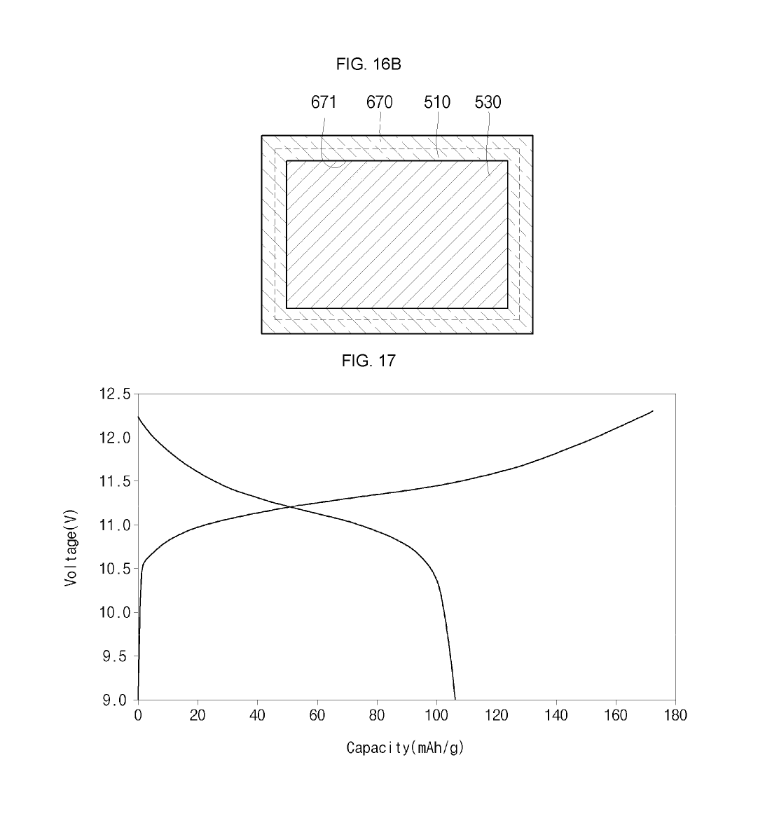

FIG. 17 is a graph illustrating performance evaluation results of the bipolar all solid-state battery according to still another embodiment of the present invention.

Referring to FIG. 17, performance tests were carried out on trial products of the bipolar all solid-state battery according to still another embodiment of the present invention, in which 3 unit cells are stacked and connected to each other in series and finally assembled using a pouch case.

As confirmed from the results illustrated in FIG. 17, after the battery stack 40 was charged, an open circuit voltage (OCV) of the battery stack 40 was approximately 12.3 V and an average discharge voltage of the battery stack 40 was 11.1 V, which is substantially equal to a discharge voltage of each unit cell, that is, approximately 3.7 V. In addition, when the battery stack 40 was discharged with a current density of 0.05 C at 70° C., a capacity of the battery stack 40 was identified as approximately 105 mAh/g, which is substantially equal to a discharge capacity of each unit cell. In addition, the battery stack 40 demonstrated superior reversibility during charge and discharge cycles. Therefore, the cell/stack of the bipolar all solid-state battery according to the present invention can be easily manufactured, and quality problems, such as short-circuits, can be efficiently controlled.

While the bipolar all solid-state battery of the present invention has been particularly shown and described with reference to specific embodiments thereof, it will be understood by those of ordinary skill in the art that various changes in form and details may be made therein without departing from the spirit and scope of the present invention as defined by the following claims.

What is claimed is:

1. A bipolar all solid-state battery comprising a unit cell including:
a first current collector having a first surface and a second surface opposite to the first surface;
a first active material coated on the first surface of the first current collector;
a second current collector having a first surface and a second surface opposite to the first surface;
a second active material coated on the first surface of the second current collector and facing the first active material; and
an all solid-state electrolyte formed between the first active material and the second active material,
wherein when a plurality of the unit cells are stacked, the first current collector and the second current collector are connected to each other through surface contact.

2. The bipolar all solid-state battery of claim 1, wherein the first current collector is made of aluminum or an aluminum alloy.

3. The bipolar all solid-state battery of claim 1, wherein the second current collector is made of copper or a copper alloy.

4. The bipolar all solid-state battery of claim 1, wherein the first current collector and the second current collector are made of stainless steel (SUS), nickel or a nickel alloy.

5. The bipolar all solid-state battery of claim 1, further comprising an adhesive or paste formed on at least one surface of at least one of the first current collector and the second current collector, the adhesive or paste including a metal selected from the group consisting of platinum, silver, gold and nickel.

6. The bipolar all solid-state battery of claim 1, wherein the first current collector is configured to have a larger area than the second current collector.

7. The bipolar all solid-state battery of claim 1, wherein the all solid-state electrolyte is configured to have a larger area than the first and second current collectors.

8. The bipolar all solid-state battery of claim 1, further comprising an insulation film formed on boundaries between the first current collector and the second current collector when the unit cells are stacked.

9. The bipolar all solid-state battery of claim 8, wherein the insulation film includes one selected from the group consisting of polyimide (Pl), polyethylene (PE) and polypropylene (PP).

10. The bipolar all solid-state battery of claim 8, wherein the insulation film includes a throughhole formed therein to expose the first current collector and the second current collector being in surface contact.

11. The bipolar all solid-state battery of claim 8, wherein the insulation film includes styrene butadiene rubber (SBR) coated on at least one of its top and bottom surfaces to then be attached to at least one of the first current collector and the second current collector.

12. The bipolar all solid-state battery of claim 1, wherein surface treatment is performed on at least one of the second surface of the first current collector and the second surface of the second current collector.

13. A bipolar all solid-state battery comprising a unit cell including:
a bipolar current collector having a first surface and a second surface opposite to the first surface;
a first active material coated on the first surface of the bipolar current collector;
a second active material coated on the second surface of the bipolar current collector; and
an all solid-state electrolyte formed between the first active material and the second active material,
wherein the second active material is formed by attaching a lithium foil to the second surface of the bipolar current collector.

14. The bipolar all solid-state battery of claim 13, wherein the bipolar current collector is made of stainless steel (SUS), nickel, a nickel alloy or a clad metal of aluminum and copper.

15. The bipolar all solid-state battery of claim 13, wherein the first active material is configured to have a larger area than the second active material.

16. The bipolar all solid-state battery of claim 13, wherein the all solid-state electrolyte is configured to have a larger area than the first and second active materials.

17. The bipolar all solid-state battery of claim 13, further comprising an insulation film formed on a top surface of the bipolar current collector to surround the second active material.

18. The bipolar all solid-state battery of claim 17, wherein the insulation film includes one selected from the group consisting of polyimide (Pl), polyethylene (PE) and polypropylene (PP).

19. A method of manufacturing a bipolar all solid-state battery, the method comprising:
providing a bipolar current collector structure by winding the bipolar current collector on a roll, the bipolar current collector including a first active material formed on its first surface and a second active material formed on its second surface;
providing an all solid-state electrolyte structure by winding the all solid-state electrolyte on a separate roll to; and
supplying the bipolar current collector structure and the all solid-state electrolyte structure between two rotating rollers and compressing the supplied structures using the rollers.

20. The method of claim 19, wherein the second active material is formed by attaching a lithium foil to the second surface of the bipolar current collector.
